(19) United States
(12) Patent Application Publication
(10) Pub. No.: US 2025/0013031 A1
(43) Pub. Date: Jan. 9, 2025

(54) SMARTPHONE MAGNETIC PLATE

(71) Applicant: Magview, LLC, Lake Oswego, OR (US)

(72) Inventors: Mark J. Hayes, Onalaska, WI (US); John R. Scovil, Onalaska, WI (US)

(73) Assignee: Magview, LLC, Lake Oswego, OR (US)

(21) Appl. No.: 18/758,048

(22) Filed: Jun. 28, 2024

Related U.S. Application Data
(60) Provisional application No. 63/525,110, filed on Jul. 5, 2023.

(51) Int. Cl. G02B 23/16; G02B 25/00

(52) U.S. Cl. CPC G02B 23/16; G02B 25/002

(57) ABSTRACT

A scope mount assembly for attaching an optical scope having first and second eyepieces to an electronic accessory having a lens. The scope mount assembly broadly comprises a scope mount and a target attachable to the electronic accessory. The scope mount is configured to engage the first eyepiece. The scope mount includes an aperture for viewing through the first eyepiece when the optical scope is not attached to the electronic accessory and a magnet positioned near the aperture. The target includes a body formed of a structural material and a powder particulate. The powder particulate is distributed throughout the structural material and includes a material configured to be attracted to the magnet. The target is positionable on the electronic accessory so that the second eyepiece aligns with the lens of the electronic accessory when the scope mount magnetically engages the target.

### RELATED APPLICATIONS

The present application claims the priority benefit of U.S. Provisional Patent Application Ser. No. 63/525,110, filed Jul. 5, 2023, entitled SMARTPHONE MAGNETIC PLATE, incorporated by reference in its entirety herein.

### BACKGROUND

Digiscoping adapter systems often include a magnetically attractive target that is attachable to an electronic accessory such as a smartphone. Unfortunately, such magnetically attractive targets can inhibit wireless charging of the electronic accessory. For example, a target may be oriented between a receiving coil (i.e., power receiving unit) of the electronic accessory and an inductive charger (i.e., power sending unit) during wireless charging. A target made of solid metal such as iron or steel can prevent wireless charging altogether. A relatively thick target increases a distance between the receiving coil and inductive charger, thereby reducing wireless charging effectiveness. Relatively large magnetic particles in the target create eddy currents that also reduce wireless charging effectiveness. Targets are also susceptible to corrosion when used in outdoor environments.

### SUMMARY

Embodiments of the invention solve the above-mentioned problems and other problems by providing a distinct advance in the art of mounts for optical scopes. More particularly, the invention provides an optical scope mount assembly including a magnetically attractive target attachable to an electronic accessory, wherein the target allows uninhibited wireless charging of the electronic accessory. The target is also resistant to corrosion.

An embodiment is a scope mount assembly for attaching an optical scope having first and second eyepieces to an electronic accessory having a lens. The scope mount assembly broadly comprises a scope mount and a magnetically attractive target attachable to the electronic accessory. The scope mount is configured to engage the first eyepiece of the optical scope. The scope mount includes an aperture for viewing through the first eyepiece when the optical scope is not attached to the electronic accessory and a magnet positioned near the aperture. The target broadly comprises a body formed of a structural material and a powder particulate. The powder particulate is distributed throughout the structural material. The powder particulate includes a material configured to be attracted to the magnet. The powder particulate material is at least seventy percent of the body by weight. The target is positionable on the electronic accessory so that the second eyepiece of the optical scope aligns with the lens of the electronic accessory when the scope mount magnetically engages the target.

Another embodiment is a target for attaching an optical scope to an electronic accessory via a scope mount. The target broadly comprises a body formed of a structural material and a number of particles distributed throughout the structural material. The particles include a ferrous material and account for at least seventy percent of the body by weight.

Yet another embodiment is a target for attaching an optical scope to an electronic accessory via a scope mount. The target broadly comprises a body having a thickness of 0.12 inches or less. The body includes a nonmagnetic material and a stainless steel powder particulate distributed throughout the nonmagnetic material. The powder particulate includes a corrosion resistant iron alloy with particles having an average size of 0.02 inches or less. The powder particulate accounts for at least seventy percent of the body by weight.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a scope mount assembly constructed in accordance with an embodiment of the invention; and

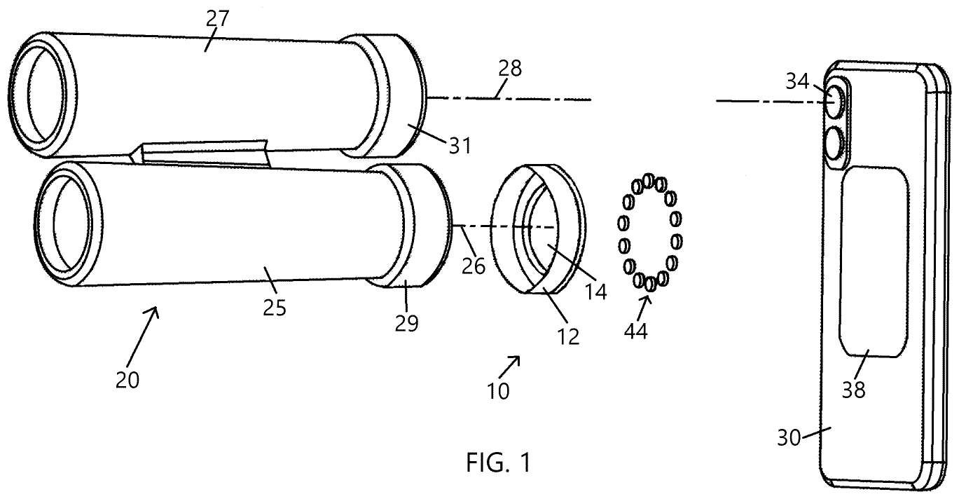

FIG. 2 is a perspective view of a target of a scope mount assembly, the target being constructed in accordance with another embodiment of the invention.

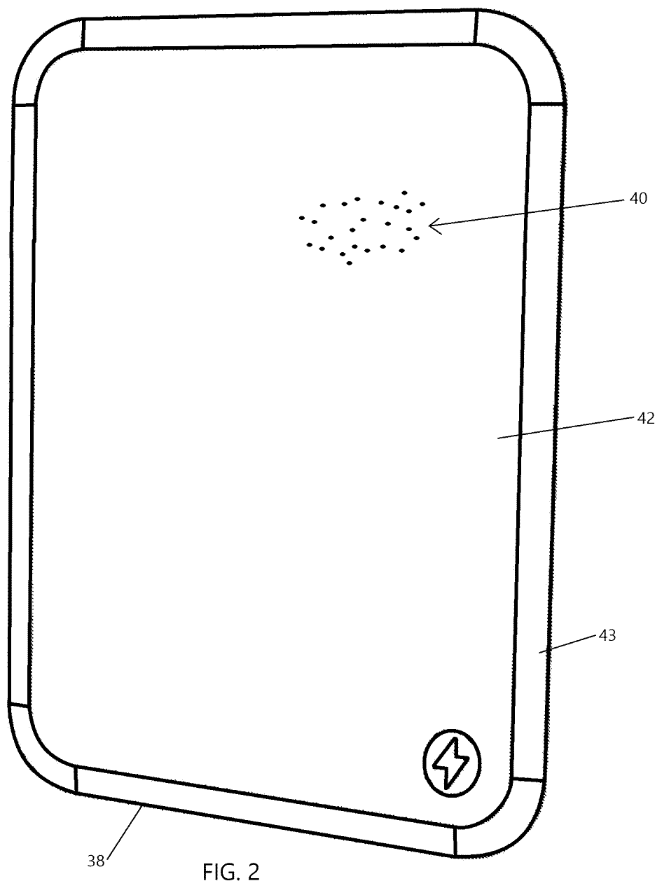

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Turning to the drawing figures, a scope mount assembly 10 (hereinafter mount assembly 10) constructed in accordance with an embodiment of the invention is illustrated. The mount assembly 10 broadly comprises a ring 12, a plurality of magnets 44, and a target 38. The mount assembly 10 can be used for attaching an optical scope 20 to an electronic accessory 30.

The optical scope 20 may be binoculars or a similar device including a first ocular structure 25 having a first eyepiece 29 aligned on a first viewing axis 26. The optical scope 20 may also include a second ocular structure 27 having a second eyepiece 31 aligned on a second viewing axis 28.

The electronic accessory 30 may be a smartphone, tablet, laptop computer, video capturing device, personal digital assistant, or the like having a lens 34. The electronic accessory 30 may be capable of capturing images and/or video through the lens 34.

The ring 12 may be configured to engage the first eyepiece 29 of the optical scope 20 and may include a central aperture 14 to allow normal viewing through the first eyepiece 29 of the optical scope 20 when the optical scope is not attached to the electronic accessory 30. The ring 12 may include structure for housing the plurality of magnets 44 in a circular arrangement around the central aperture 14. The ring 12 may be formed of rubber, plastic, metal, or any other suitable material.

The plurality of magnets 44 may be distributed in a circular pattern around the central aperture 14 of the ring 12 so that the magnets 44 are distributed about the eyepiece of the optical scope 20 when the ring 12 is positioned on the second ocular structure of the optical scope 20. The magnets 44 may be arranged in a circle such that the magnets 44 are entirely within a diameter of 1 inch to 1.5 inches.

The target 38 may be a thin sheet or pad comprising a magnetically attractive material for engaging the magnets 44 via magnetic attraction. The target 38 may also be attached to or configured to be attached to the electronic accessory 30 via adhesive, fasteners, specially placed magnets, or the like.

The target 38 may comprise a composition that is magnetically attractive but does not prevent wireless charging of the electronic accessory 30. To that end, the target 38 may include magnetically attractive particles 40 distributed in a body material 42. The particles 40 may comprise a particulate material such as powder.

The particles 40 may comprise a particulate material such as powder. The particles 40 may comprise a ferrous material such as iron, iron alloy, or steel. The particles 40 may comprise a corrosion or rust resistant iron alloy such as stainless steel. Yet other exemplary materials the particles 40 may comprise include a ferritic stainless steel, a magnetic stainless steel, and SAE Steel Grade 400 Series stainless steel. Corrosion resistant particles may be desirable because the target 38 may often be used in outdoor environments.

The target 38 may comprise a body material 42 suitable to provide structural integrity to the target 38 and to contain the particles 40. The body material 42 may comprise a resin, a polymer such as thermoplastic or thermosetting polymer, an epoxy, a 2-part epoxy, acrylonitrile butadiene styrene (ABS) plastic, a non-elastomeric material, elastomer, a nonferrous material, and a non-magnetic material.

The target 38 may have any suitable size and shape. In one embodiment, the target 38 may be rectangular and may have filleted corners. The target 38 may have sufficient length and width to engage all of the magnets 44 simultaneously. In one embodiment, the target 38 has a length of at least one inch and a width of at least one inch. In another embodiment, the target 38 has a length of between 2.5 inches and 4 inches. In another embodiment, the target 38 has a width of between 1.5 inches and 2.5 inches. In yet another embodiment, the target 38 has a length greater than its width. In still another embodiment, the target 38 has a length of between 3 inches and 3.5 inches and a width of between 2 inches and 2.5 inches. The target 38 may be sized for use with a smartphone and have a width that is less than a width of the smartphone.

A thickness of the target 38 can impact wireless charging of the electronic accessory 30, which may be due to physical location of the electronic accessory 30 with respect to a wireless charger as well as eddy currents caused by particles 40 in the target 38. The target 38 may have a length substantially greater than its thickness. In another embodiment, the target 38 has a width substantially greater than its thickness. In yet another embodiment, the target 38 may have a thickness of 0.12 inches ( 3/25 inches) or less. In still another embodiment, the target 38 may have a thickness of 0.08 inches ( 2/25 inches) or less. In yet another embodiment, the target 38 may have a thickness of 0.04 inches ( 1/25 inches) or less.

The target 38 may comprise any suitable proportion of particles 40 relative to the body material 42. In one embodiment, the target 38 may include between 60% and 90% particles 40 by weight, with the remainder comprising the body material 42. In another embodiment, the target 38 may comprise between 70% and 80% particles 40 by weight, with the remainder comprising the body material 42. In yet another embodiment, the target 38 may comprise between 72% and 78% particles 40 by weight, with the remainder comprising the body material 42. In still another embodiment, the target 38 may comprise 76% particles 40 and 24% body material 42 by weight.

The particles 40 may have any suitable size and shape. The particles 40 may be relatively small, with a maximum dimension of each particle 40 being less than a thickness of the target 38. In one embodiment, each particle 40 has a size of approximately 0.02 inches (⅕ inch) or less. In another embodiment, each particle 40 has a size of approximately 0.012 inches ( 12/1000 inch) or less. In yet another embodiment, each particle 40 has a size of approximately 0.006 inches ( 6/1000 inch) or less. The particles 40 may be in powder form. The particles 40 may be a ferrous powder, with the particles 40 being distributed in the body material 42. The particles 40 may be a powder having a range of different particle sizes such that the particles 40 have an average particle size corresponding to the sizes listed above. Eddy currents caused by smaller particles 40 may have less effect on wireless charging than eddy currents caused by larger particles 40.

The target 38 may have a reduced thickness near its outer edges. A reduced thickness near the target's edges may make the target 38 more ergonomic and less noticeable when attached to the electronic accessory 30. The target 38 may have a bevel 43 extending around its perimeter. The target 38 may have a tapered edge portion.

The target 38 may be made via any suitable method. In one embodiment, the particles 40 are combined with a precursor to the body material 42 such as a resin or prepolymer to form a mixture. The mixture can be shaped according to the desired shape of the target 38 and the body material 42 may then be cured to finalize the shape. In another embodiment, two or more materials may be mixed to form the precursor material such as a 2-part epoxy. The mixture may be shaped using a mold. The mixture may be injected into the mold. In yet another embodiment, for example when the body material 42 comprises a thermoplastic, heat may be applied to melt a polymer. The particles 40 may then be mixed with the melted polymer and molded to form the target 38. The body material 42 may then be cooled so that it solidifies.

The above-described scope mount assembly 10 provides several advantages. For example, the target 38 allows uninhibited wireless charging of the electronic accessory 30. The target 38 is also corrosion resistant. Furthermore, the central aperture 14 of the ring 12 allows normal viewing through the optical scope 20 without the need to remove the ring 12 from the optical scope 20.

Additional features not specifically discussed may be found in US Pat. App. Pub. No. 2022/0299748. US Pat. App. Pub. No. 2022/0299748 is hereby incorporated by reference in its entirety into the present patent application.

### ADDITIONAL CONSIDERATIONS

This description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. This description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods may be illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 110(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A scope mount assembly for attaching an optical scope having first and second eyepieces to an electronic accessory having a lens, the scope mount assembly comprising:
a scope mount configured to engage the first eyepiece of the optical scope, the scope mount including:
an aperture for viewing the optical scope through the first eyepiece when the optical scope is not attached to the electronic accessory; and
a magnet positioned near the aperture; and
a target comprising:
a body formed of:
a structural material; and
a powder particulate distributed throughout the structural material, the powder particulate including a material configured to be attracted to the magnet and being at least seventy percent of the body by weight,
the target being positionable on the electronic accessory so that the second eyepiece of the optical scope aligns with the lens of the electronic accessory when the scope mount magnetically engages the target.

2. The scope mount assembly of claim 1, wherein the structural material is nonmagnetic.

3. The scope mount assembly of claim 1, the target having a thickness of 0.12 inches or less.

4. The scope mount assembly of claim 1, the powder particulate including particles having an average size of 0.02 inches or less.

5. The scope mount assembly of claim 1, the target being rectangular.

6. The scope mount assembly of claim 1, the powder particulate including particles each having a maximum dimension less than a thickness of the target.

7. A target for attaching an optical scope to an electronic accessory via a scope mount, the target comprising:
a body formed of:
a structural material; and
a plurality of particles distributed throughout the structural material, the plurality of particles comprising a ferrous material and being at least seventy percent of the body by weight.

8. The target of claim 7, the structural material comprising a resin.

9. The target of claim 7, the structural material comprising a polymer.

10. The target of claim 7, the structural material comprising a nonmagnetic material.

11. The target of claim 7, the body having a thickness of 0.12 inches or less.

12. The target of claim 11, the body having a width dimension of 2.5 inches or less.

13. The target of claim 7, the plurality of particles comprising a corrosion resistant material.

14. The target of claim 7, the plurality of particles comprising magnetic stainless steel.

15. The target of claim 7, the plurality of particles comprising magnetic stainless steel.

16. The target of claim 7, the plurality of particles comprising an average size of 0.02 inches or less.

17. The target of claim 7, the body comprising a bevel.

18. The target of claim 7, wherein a maximum dimension of each particle is less than a thickness of the target.

19. A target for attaching an optical scope to an electronic accessory via a scope mount, the target comprising:
a body having a thickness of 0.12 inches or less, the body comprising:
a nonmagnetic material; and
a stainless steel powder particulate distributed throughout the nonmagnetic material,
wherein the powder particulate comprises a corrosion resistant iron alloy including particles having an average size of 0.02 inches or less, the powder particulate being at least seventy percent of the body by weight.

20. The target of claim 19, the powder particulate including particles each having a maximum dimension less than a thickness of the target.
